(19) United States
(12) Patent Application Publication
(10) Pub. No.: US 2016/0183732 A1
(43) Pub. Date: Jun. 30, 2016

(54) MIXED DRINK SYSTEM

(71) Applicant: Wallace Littrell, Vilonia, AR (US)

(72) Inventor: Wallace Littrell, Vilonia, AR (US)

(21) Appl. No.: 14/964,698

(22) Filed: Dec. 10, 2015

Related U.S. Application Data
(63) Continuation-in-part of application No. 14/600,007, filed on Jan. 19, 2015, now abandoned.
Application No. 14/600,007 is a continuation-in-part of application No. 13/862,005, filed on Apr. 12, 2013, now abandoned.

(51) Int. Cl. A47J 43/27

(52) U.S. Cl. CPC A47J 43/27

(57) ABSTRACT

The present invention relates a mixed drink system for creating a mixed drink comprising: a container, where said container includes a liquid; a jigger cap, where the cap seals the container; a sealed compartment within the cap, where said compartment includes a second liquid; and a releasable divider, where said divider seals the compartment of the jigger cap. In one exemplary embodiment, the container is a bottle and the liquid is a soda, water, club soda, juice, cream or milk. The second liquid may be distilled liquor such as gin, rum, tequila, vodka, whiskey, bourbon or scotch. The compartment may include an opening, where the opening provides a means to release the liquid into the container.

### CROSS REFERENCE TO OTHER APPLICATIONS

This application is a continuation in part to U.S. patent application Ser. No. 14/600,007 filed on Jan. 19, 2015.

### BACKGROUND OF THE INVENTION

1. Field of Invention

The present invention relates to a mixed drink system that includes a cap design to attach to a bottle where the cap includes sufficient alcohol to create a mixed drink with the liquids within the bottle.

2. Description of Related Art

A mixed drink is a popular drink that involves the mixture of alcohol and a mixer such as soda, juice, milk or ice cream that is enjoyed by individuals who consume alcohol. A mixture of the drink involves the pouring of alcohol and the desired mixture into a glass or a shaker and allowing the combined liquids to blend to create a unique taste for each drink. The mixed drink includes distilled liquor such as whiskey, bourbon, vodka, gin, tequila, or scotch. The distilled liquor is mixed with a mixer where the mixer is usually a soda, water, a liqueur, cream, milk and/or ice. A bartender or consumer must have a container of the distilled spirit usually in a bottle and then mix the distilled spirit with the mixer that comes in a separate bottle or container. The use of separate bottles is due to the various types of mixers used and the various types of distilled liquors mixed with mixers.

In order to provide a convenient mixed drink it would be advantageous to have a bottle that included the mixer within one compartment and the distilled liquor in the separate compartment where the two may be combined at the time of consumption. It would also be advantageous for the distilled liquor compartment or at least one compartment be used as a cap for the bottle and therefore contained and separated from the mixer. Use of such a device could obviate the need for multiple bottles and containers in order to serve a mixed drink.

### SUMMARY OF THE INVENTION

The present invention relates a mixed drink system for creating a mixed drink comprising: a container, where said container includes a liquid; a jigger cap, where the cap seals the container; a sealed compartment within the cap, where said compartment includes a second liquid; and a releasable divider, where said divider seals the compartment of the jigger cap. In one exemplary embodiment, the container is a bottle and the liquid is a soda, water, club soda, juice, cream or milk. The second liquid may be distilled liquor such as gin, rum, tequila, vodka, whiskey, bourbon or scotch. The compartment may include an opening, where the opening provides a means to release the liquid into the container.

### BRIEF DESCRIPTION OF DRAWINGS

FIG. 1 depicts a mixed drink system according to the present invention.

FIG. 2 depicts a cross sectional view of a jigger cap according to the present invention.

FIG. 3 depicts a second cross section view showing movement of a plunger in the jigger cap according to the present invention.

### DETAILED DESCRIPTION

The present invention relates to a mixed drink system that provides a convenient single bottle that can create a mixed alcoholic drink at the time of consumption. The present invention includes a bottle that contains a mixer such as soda, water, juice, or a cream and a detachable jigger cap that encloses distilled spirits or alcohol for mixture with the contents of the bottle. The user may remove a divider provided on the bottom of the jigger cap to release the alcohol into the bottle and create the mixed drink for consumption. The bottle and drink combination may vary in size based upon the desired mixed drink and contents thereof.

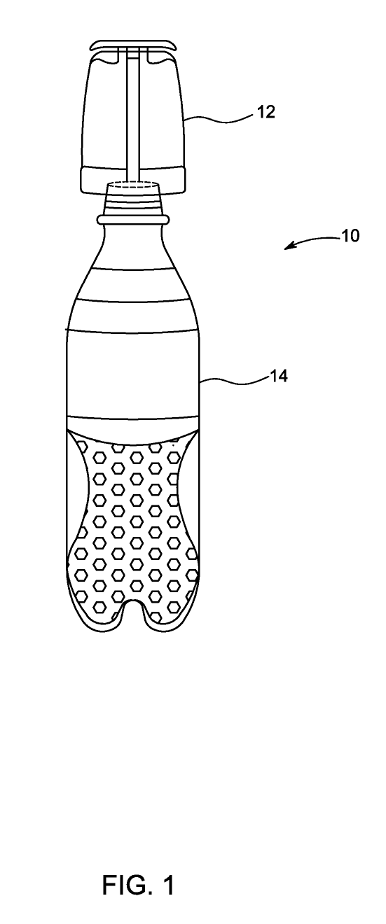

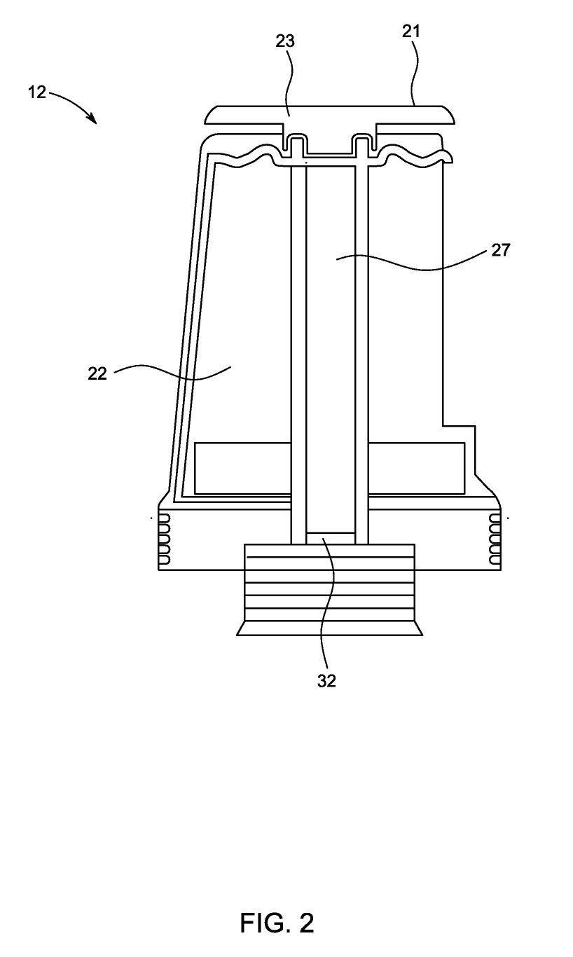

In reference to FIG. 1 a depiction of the mixed drink system 10 according to the present invention is depicted. The drink system 10 includes a Bottle 14 with a Jigger Cap 12. The Jigger Cap 12 seals the Bottle 14, which may contain a mixer such as a soda, water, club soda or other known mixers. The Jigger Cap 12 provides the means to seal the Bottle 14 and also contains in a compartment shown in FIG. 2 that includes distilled liquor such as gin, rum, tequila, vodka, whiskey, bourbon or scotch.

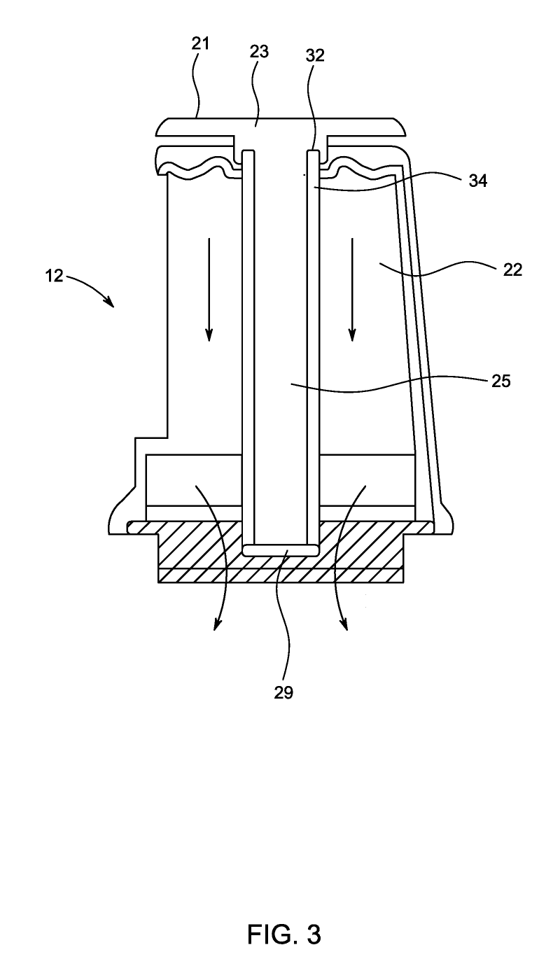

FIG. 1 shows the Cap 12 attached to a Beverage Bottle 14. The Cap 12 includes the Liquid Area 22. As stated above the liquid within the liquid area in the preferred embodiment may include a distilled liquor. This distilled liquor is enclosed within the Cap 12 in the liquid area. At the top of the Cap 12 is a Plunger Button 21. The plunger button provides the means to release the liquid from the liquid area and dispersement into the Bottle 14. The Plunger 21 includes a Top Button 23. The Top Button 23 is connected to a Stem 25 shown in FIG. 3. The Stem 25 extends through a Column 27 provided in the center of the Cap 12. At the bottom of the Stem 25 is a Base 29. The Base 29 depresses through a Fluid Barrier 32 shown clearly in FIG. 2, to activate the release of the liquid within the Liquid Area 22. The stem connected to the Button 23 at a Button Seat 33 where the Button Seat 33 fits around a lip a Lip 34 provided at the top of the Cap 12. Upon depression of the Button 23 by the user the flow of liquid flows through the exposed Fluid Barrier 32. In one particular embodiment the fluid barrier may be made of plastic foil for film such that it provides a tight seal for the Liquid Area 22. However it may be punctured with the Base 29 of the Stem 25.

FIG. 2 depicts a cross sectional view of the Jigger Cap 12 that shows the inner compartment that stores Liquid Area 22 therein. The Liquid Area 22 stored within the Jigger Cap 12 is readily released by the user to create a mixed drink with the mixer within the Bottle 14.

The Jigger Cap 12 seals the Bottle 14 and is detachable in order to release the alcohol contents into the mixer provided in the Bottle 14. The Drink System 10 may come in various sizes and the contents may be varied in order to create some common mixed drinks such as vodka and tonic, rum and coke, whiskey and 7-up, gin and orange juice, to name a few exemplary mixed drinks that may be created with the drink system according to the present invention. The drink system also provides pre-measured contents whereas to provide adequate amounts of distilled liquor within the Jigger Cap 12 with a suitable amount of mixer within the Bottle 14. Use of the drink system according to the present invention provides a practical and convenient use to create mixed drinks and obviates the need to buy multiple bottles of mix and the actual alcohol in order to create the mixed drink. Further the Drinking System 10 may provide a single mixed drink or multiple mixed drinks within the bottle depending on the amount of mixer and alcohol provided in the Jigger Cap 12. The drink mix system according to the present invention provides two separate compartments to house the desired liquids for mixture and consumption.

In addition to the preferred embodiment above, the Drink System 10 may be used two mix ingredients related to vitamin supplements, energy drinks and medicinal solutions. In any of these applications the Drink System 10 provides a quick and efficient method to mix solutions in a single bottle with the Jigger Cap 12. The instant invention has been shown and described in what it considers to be the most practical and preferred embodiments. It is recognized, however, that departures may be made there from within the scope of the invention and that obvious modifications will occur to a person skilled in the art.

What is claimed is:

1. A mixed drink system for creating a mixed drink comprising:
a. a container, where said container includes a first liquid;
b. a jigger cap, where jigger cap includes a liquid area compartment and said liquid area compartment includes a second liquid;
c. a plunger button at the top of the jigger cap, where the plunger button includes a stem extending through a column traveling through the liquid area compartment;
d. a fluid barrier at the bottom of the jigger cap; and
e. a base at the bottom of the stem, where the base is capable of penetrating the fluid barrier upon depression of the plunger button.

2. The mixed drink system according to claim 1, where the container is a bottle.

3. The mixed drink system according to claim 1, where the first liquid is at least one of a soda, water, club soda, juice, cream and milk.

4. The mixed drink system according to claim 1, where the second liquid is distilled liquor.

5. The mixed drink system according to claim 4, where said distilled liquor includes at least one of gin, rum, tequila, vodka, whiskey, bourbon and scotch.
